(19) United States
(12) Patent Application Publication
(10) Pub. No.: US 2018/0263189 A1
(43) Pub. Date: Sep. 20, 2018

(54) CULTIVATION OF CROPS

(71) Applicant: Desert Blooms LLC, Wilmington, DE (US)

(72) Inventors: Rebecca Lily Oppenheimer, Johannesburg (ZA); Gary Alan Larsen, Tenino, WA (US)

(21) Appl. No.: 15/857,164

(22) Filed: Dec. 28, 2017

(30) Foreign Application Priority Data
Mar. 16, 2017 (ZA) 2017/01870

(51) Int. Cl. A01G 9/02; A01G 27/00

(52) U.S. Cl. CPC A01G 9/02; A01G 9/022; A01G 9/027; E03B 3/03; A01G 27/003; A01G 27/001; A01G 27/006

(57) ABSTRACT

The invention provides a crop cultivation receptacle. The receptacle comprises a base and side walls that project from the base to define a receptacle space between them. In the receptacle space, a body of growth medium for the cultivation of crops can in use be contained such that a major portion thereof is spaced from the base. The receptacle also comprises at least one recess that is defined in the base. Into the recess, a minor portion of the body of growth medium can extend and in which the minor portion of the body of growth medium can be contained. The receptacle further comprises water feed control means that limits water feed to the receptacle space so as not to exceed a predetermined depth of water in the receptacle space above non-recessed portions of the base.

### FIELD OF THE INVENTION

THIS INVENTION relates to the cultivation of crops. More particularly, the invention relates to the cultivation of crops in crop cultivation receptacles. The invention provides a crop cultivation receptacle. The invention also provides a crop cultivation assembly and an extended crop cultivation assembly, both including the crop cultivation receptacle. The invention further provides a crop cultivation arrangement.

### BACKGROUND TO THE INVENTION

WATER IS SCARCE. The reach of this statement around the world and the potentially catastrophic impact of its content become more pronounced each day. Shortages of drinking water are compounded by a concomitant requirement for water to irrigate and thus cultivate crops, to provide food security. The necessity to use available water efficiently cannot be overstated.

Operations of intensive and, in some cases, extensive commercial farming in developed and in some underdeveloped countries are often served by extensive infrastructure that allows them to leverage remote water sources, including remote catchment areas and perennial natural water sources such as rivers. Such infrastructure may include, for example, artificial waterways such as canals, extensive pipe networks, and bulk water reservoirs such as dams, all of which provide for water supply security over long periods of time. There are many more areas, however, where self-sustaining agricultural operations, e.g. subsistence farming practises, are necessary, but which lack the abovementioned infrastructure.

People residing in areas lacking in such water supply infrastructure, and more so in areas that are also impractically far away from natural sources of sustainable water supply, such as perennial rivers, are often ill-equipped to leverage those natural sources of water that are available to them in an efficient and sustainable manner in order to establish self-sustaining food security. The applicant has identified refugees as being people that are particularly vulnerable in this regard.

Refugees usually find themselves in situations in which there is an urgent need for resources, which includes food security. Regularly, this need is satisfied by intensive outside input in the form of humanitarian aid, but often such aid is of a temporary nature. Furthermore, the provision of such aid is not naturally conducive to the promotion of self-sustaining practises, delays in the development of which are often exacerbated by the expectation that the settlement would be temporary, which more often than not turns out not to be the case. In cases in which humanitarian aid is not provided, people suffer extreme hardship while trying to establish themselves in in a sustainable manner in an environment that is often hostile.

The present invention seeks to empower people in the situations alluded to above, particularly by enabling them to commence self-sustaining agricultural practises within a short period of time by extensively leveraging those natural resources that they have available to them.

### SUMMARY OF THE INVENTION

IN ACCORDANCE WITH THE INVENTION, BROADLY, IS PROVIDED a crop cultivation receptacle that comprises
a base and side walls that project from the base to define a receptacle space between them, in which receptacle space a body of growth medium for the cultivation of crops can in use be contained such that a major portion thereof is spaced from the base;
at least one recess that is defined in the base, into which recess a minor portion of the body of growth medium can extend and in which the minor portion of the body of growth medium can be contained; and
water feed control means that limits water feed to the receptacle space so as not to exceed a predetermined depth of water in the receptacle space above non-recessed portions of the base.

MORE SPECIFICALLY, IN ACCORDANCE WITH ONE ASPECT OF THE INVENTION IS PROVIDED a crop cultivation receptacle which comprises
a base;
side walls that project from the base;
a receptacle space that is defined between the base and the side walls, in which receptacle space water and a body of plant growth medium for cultivating plants can, in use, be held;
a first recess in the base, the first recess thus being sunken relative to the base, and the first recess being in fluid communication with the receptacle space;
a water supply control valve that is arranged to supply, in use, water to the receptacle from a water supply, and that can be opened and closed selectively to allow and disallow such supply of water; and
a buoyant member that is arranged for buoyant displacement along at least a part of the first recess, wherein displacement of the buoyant member is caused, in use, by changes in a level of water that is contained in the first recess, or by changes in a level of water that is contained in the receptacle space when the first recess has overflowed with water, such that
   the water supply control valve is closed due to displacement of the buoyant member by the level of water reaching, in use, a predetermined maximum level in the receptacle space; and
   the water supply control valve is opened due to displacement of the buoyant member by the level of water reaching, in use, a predetermined minimum level, in the first recess.

The receptacle may comprise an additional recess in the base, into which recess, in use, a minor part of a body of growth medium, which is in use contained in the receptacle space, extends. A major portion of the body of growth medium may be spaced from the base. Typically, the receptacle would comprise more than one such additional recess.

The receptacle space may be separated, by a separation member that traverses the receptacle space, into a water supply zone, which includes the base and the first recessed portion, and a cultivation zone.

The separation member may have an aperture therein that is in register with the additional recess, and through which aperture the minor part of the body of growth medium, in use, extends into the additional recess. When the receptacle would comprise more than one additional recess, the separation member would of course comprise more than one aperture, typically one for each of the additional recesses. Thus, extension of growth medium from the cultivation zone into the water supply zone in use would be limited to the additional recesses.

Water that accesses the minor portion of the body of growth medium that extends into the water supply zone, and more specifically into the additional recesses in the base, would in use be provided to the major portion of growth medium through wicking, i.e. capillary action. Thus, it would in use typically be only the minor portion of the body of growth medium that is directly wetted with free water, while wetting of the major portion of the body of growth medium would be indirect.

Preferably, the sum of the surface area left open by the apertures in the separation member would be a minor portion of the total surface area of the separation member. A major portion of the separation member would therefore be such that free passage of growth medium therethrough is not readily allowed.

It will be appreciated that while the first and additional recesses are defined in the base, they are not regarded as being included in the base for the purpose of the definition of “base” afforded by this specification. Therefore, walls and bottoms of the recesses are also not regarded as forming part of the base.

It will also be appreciated that the base may therefore have non-recessed portions between the first and additional recesses. It is expected that the non-recessed portions would typically occupy a larger surface area than that which is left open in the base by mouths of the recesses. In referring to “non-recessed” portions, incidental non-functional recessing in the base, in the sense that any such incidental non-functional recessing does not serve a function as hereinbefore and hereinafter described with reference to the first and additional recesses, is excluded. This also applies to use of the term “flat”.

The buoyant member is preferably configured such that the predetermined maximum level of the water is a predetermined maximum level of water above non-recessed portions of the base. This predetermined maximum level may be relatively shallow with reference to its depth above the non-recessed portions of the base relative to the depth of the receptacle space, and typically also relative to the depth of the first and further recessed portions. More particularly, configuration of the buoyant member is preferably such that, in use, the depth of water above non-recessed portions of the base, at which the buoyant member closes the water supply valve, is between about 6 mm and about 12 mm, e.g. it may be about 10 mm.

The receptacle space may have a volume in a range of from 3 to 5 litres, e.g. it may be about 4 litres.

The receptacle may have a depth, measured to the base, in a range of from 50 mm to 75 mm, e.g. it may be about 50 mm.

Space between the non-recessed portions of the base and the separation member may be small, i.e. narrow, relative to the total volume of the receptacle space. In other words, the volume of the water supply zone outside of the recesses may be small relative to the total volume of the receptacle space. Typically, the space between the non-recessed portions of the base and the separation member may be between about 6 mm and about 18 mm, e.g. it may be about 12 mm.

The volume of unutilised water that is contained in the water supply zone, i.e. free water, is thus limited to that which is in use contained in the first recess, where it is used to control feeding of water into the water supply zone in the manner hereinbefore suggested and hereinafter described in more detail, and that which in use extends beyond the first recess into the space defined by the non-recessed portions of the base. The remainder of the water is contained in the additional recesses, where it is being utilised for irrigation and thus cultivation.

The configuration of the base set out above significantly reduces the volume of water in the water supply zone, without negatively impacting on water supply efficiency and availability when needed. This is regarded as being a particular advantage of the present invention, since it limits the operational weight of the receptacle, which makes it more versatile to handle, and safer to stack in a vertical configuration.

IN ACCORDANCE WITH ANOTHER ASPECT OF THE INVENTION IS PROVIDED a crop cultivation assembly, which comprises
a crop cultivation receptacle as hereinbefore described; and
a water reservoir which supports the crop cultivation receptacle clear of a ground surface on which the water reservoir is supported and which supplies water to the receptacle through the control valve of the receptacle, under gravity.

IN ACCORDANCE WITH ANOTHER ASPECT OF THE INVENTION IS PROVIDED an extended crop cultivation assembly which comprises
a plurality of crop cultivation receptacles as hereinbefore described; and
support structures between which the receptacles extend and which support the receptacles clear of a ground surface on which the support structures are supported, wherein the receptacles are arranged in a stacked configuration, one above the other, with clearance between them.

At least some of the support structures may comprise water reservoirs, optionally stacked assemblies of two or more water reservoirs that are interconnected for fluid communication, at least some of which water reservoirs supply, in use, water to at least one receptacle through the control valve of the receptacle.

At least some of the water reservoirs of one support structure and at least some of the water reservoirs of another support structure may be interconnected for fluid communication between the reservoirs.

IN ACCORDANCE WITH A FURTHER ASPECT OF THE INVENTION IS PROVIDED a crop cultivation arrangement which comprises a plurality of the crop cultivation assemblies hereinbefore described, of which
at least one assembly includes the support structure and at least one of the support structures has at least two receptacles that are supported by it; and/or
at least one water reservoir supports at least one other receptacle than the receptacle to which it supplies water under gravity, thus being a support structure for such at least one other receptacle; and/or
at least two water reservoirs are stacked one on top of the other.

Preferably, the arrangement comprises a plurality of pairs of water reservoirs, between which respective receptacles extend and wherein
at least some of the pairs of water reservoirs are arranged in a stacked configuration, such that their receptacles are located one above the other; and/or
at least some of the pairs of water reservoirs share at least one water reservoir for support, wherein the shared water reservoir then supports at least two receptacles, at least one of which is supplied with water from the shared water reservoir under gravity.

When one water reservoir is stacked on top of another water reservoir, the two water reservoirs may be interconnected by piping that allows water to be transferred from the higher water reservoir to the lower water reservoir. Preferably, interconnection is such that such transfer is by syphoning off water from the higher reservoir to the lower reservoir once the water reaches a predetermined level in the higher reservoir.

The arrangement may be such that at least some of the water reservoirs are arranged along an endless path, e.g. a circular path, and thus define a space between them.

The arrangement may include a rain water harvesting member, e.g. a piece of sheet material, that is arranged to harvest, i.e. collect, rain water and feed thus harvested rain water into at least one of the water reservoirs. When the arrangement includes stacked water reservoirs, the rain harvesting member would typically be arranged to feed harvested rain water into water reservoirs that do not have other water reservoirs stacked on top thereof, i.e. into the uppermost water reservoir of a stack of water reservoirs.

When the arrangement is such that at least some of the water reservoirs are arranged along an endless path and define a space between them, the rain harvesting member may traverse the space, thus providing a sheltered area below the rain harvesting member and between the assemblies of the arrangement.

THE INVENTION EXTENDS TO the receptacle, assembly, extended assembly and arrangement of the invention, respectively in use.

### BRIEF DESCRIPTION OF THE DRAWINGS

THE INVENTION IS NOW DESCRIBED in more detail with reference to the accompanying drawings in which:

FIG. 1 shows, in three-dimensional view, a crop cultivation receptacle in accordance with aspect of the first instance of the invention;

FIG. 2 shows, in top view, the crop cultivation receptacle of FIG. 1;

FIG. 3 shows, in sectional side view along A-A, the crop cultivation receptacle of FIG. 1;

FIG. 4 shows, in sectional end view along B-B, the crop cultivation receptacle of FIG. 1;

FIGS. 5a and 5b show, respectively in three-dimensional front view and three-dimensional rear view, a water reservoir for use with the crop cultivation receptacle of FIG. 1;

FIG. 6 shows, in top view, the water reservoir of FIG. 5;

FIG. 7 shows, in bottom view, the water reservoir of FIG. 5;

FIG. 8 shows, in sectional side view along C-C, the water reservoir of FIG. 5

FIG. 9a shows an assembly of the crop cultivation receptacle of FIG. 1 and the water reservoir of FIG. 5, in which the crop cultivation receptacle is shown in sectional side view (as in FIG. 3) and the water reservoir is show in conventional side view;

FIG. 9b shows, in three-dimensional top view, the assembly of FIG. 9a;

FIG. 10 shows, in three-dimensional front view, an arrangement of three pairs of the water reservoirs of FIG. 5 stacked in two parallel tower-like assemblies each comprising three of the water reservoirs, and pipe connections between water reservoirs of the respective assemblies;

FIG. 11 shows, in three-dimensional front view, two upper pairs of the three pairs or water reservoirs of the arrangement of FIG. 10, excluding the pipe connections of FIG. 10 between the water reservoirs and including mountings to mount the crop cultivation receptacle of FIG. 1 such that it extends between the uppermost pair of water reservoirs;

FIG. 12 shows, diagrammatically in top view, a part of a rain water harvesting member that is arranged to harvest and feed rain water to the water reservoir of FIG. 5;

FIGS. 13a and 13b show, diagrammatically in top view, two simple configurations of arrangements of the invention that can be provided by extending the arrangement of FIGS. 10 and 11 to include further receptacles of FIG. 1 and water reservoirs of FIG. 5;

FIG. 14 shows an extended configuration of an arrangement of the invention, without piping, along a circular path; and

FIGS. 15a and 15b respectively show more complex configurations of arrangements of the invention, which can be provided by further extension of the arrangements of FIGS. 13a and 13b.

### DETAILED DESCRIPTION OF THE INVENTION

Crop Cultivation Receptacle of the Invention

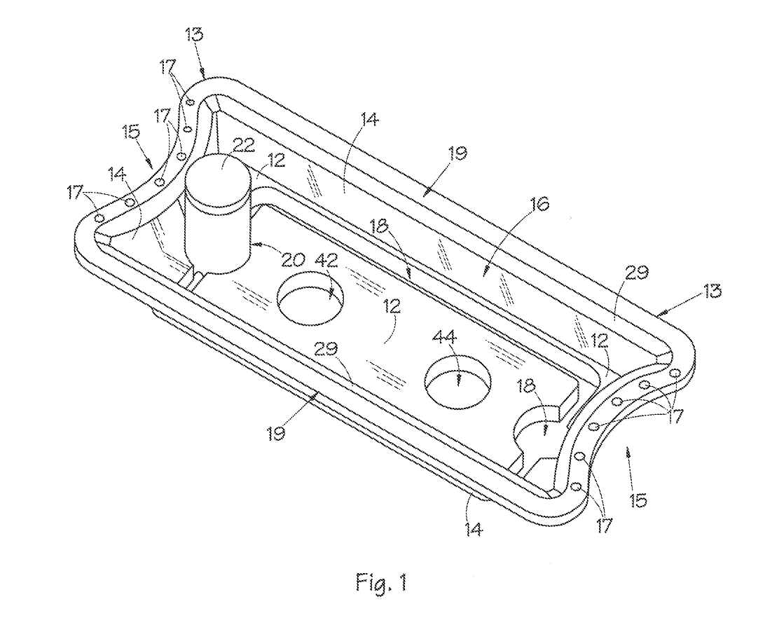

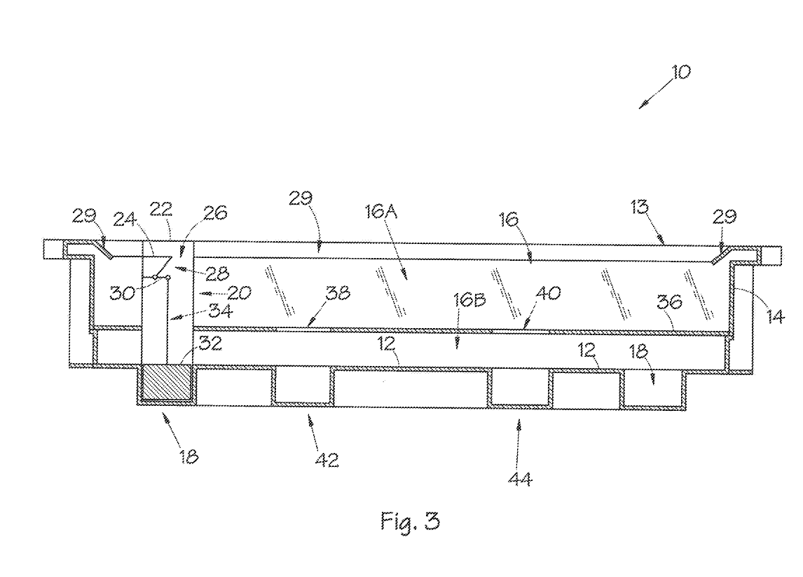

REFERRING TO THE DRAWINGS and particularly to FIGS. 1 to 4, reference numeral 10 generally indicates a crop cultivation receptacle according to the invention.

The receptacle 10 has a generally oblong hollow body that comprises a base 12 and side walls 14 projecting from the base 12. Thus, the base 12 and side walls 14 define between them a receptacle space 16 in which water and growth medium can be held in the manner hereinafter described.

The side walls 14 have a peripheral flange-like edge portion 13, extending along the entire periphery of the body 12. The edge portion 13 has concavely curved part-circular end parts 15 at opposite ends of the receptacle 10 and straight side parts 19 at opposite sides of the receptacle 10.

The part-circular end parts 15 have respective pluralities of receptacle mounting apertures 17 defined therethrough. The receptacle mounting apertures 17 are spaced angularly from each other at 11.25° about a virtual midpoint of first virtual circles, which are respective virtual circles of which the part-circular parts 15 of the edge portion 13 respectively form part.

The straight side parts 19 of the edge portion 13 each has a part-circular mounting slot 21 that extends along lower a surface thereof.

The base 12 has a first recessed portion 18 that is defined in it (in the “summary of invention” this first recessed portion is referred to as the “first recess”—these terms are interchangeable).

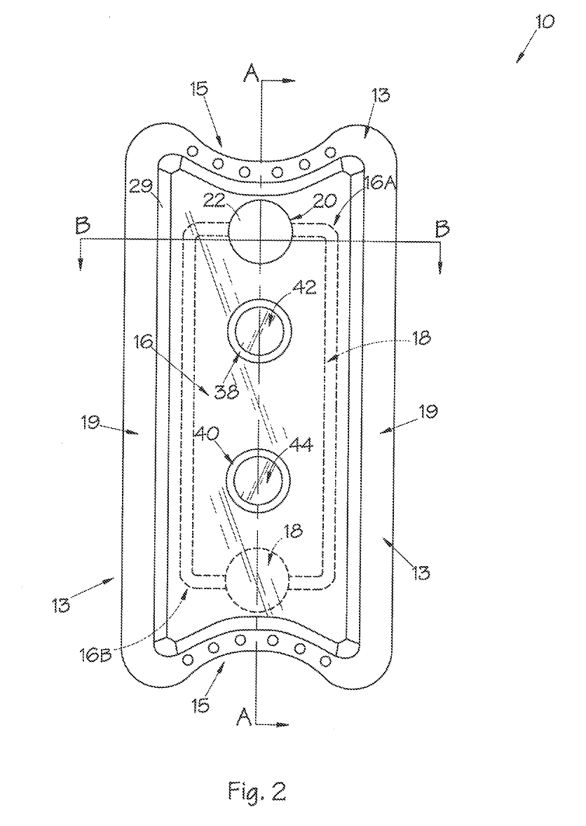

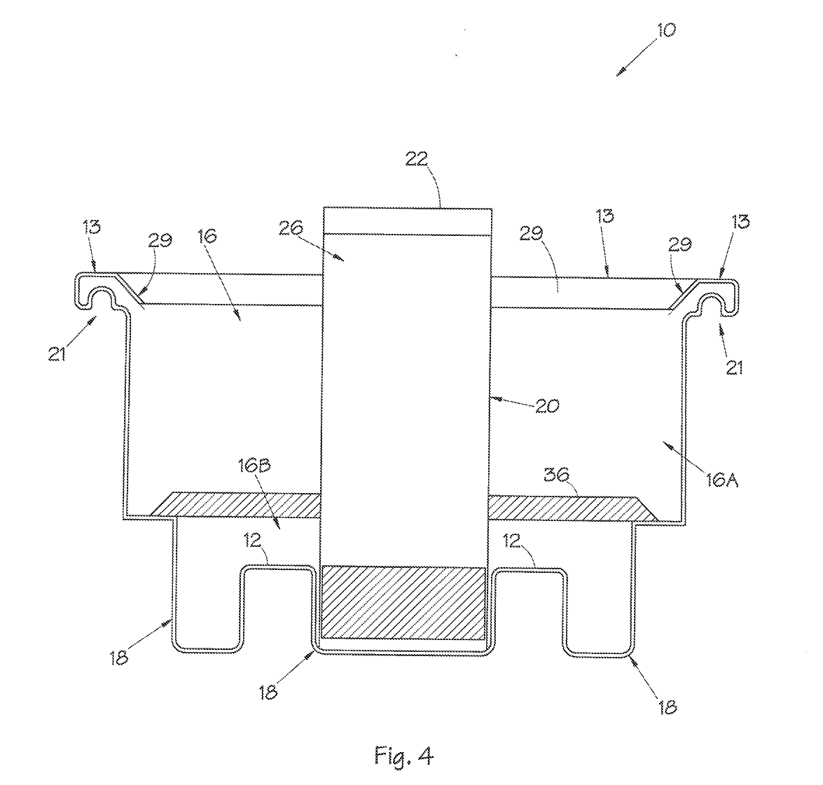

Referring to FIGS. 2 and 4, it will be seen that the first recessed portion 18 comprises a first circular cylindrical part, a peripheral channel loop part that extends along a periphery of the base 12 and a second cylindrical part that is located opposite to the first cylindrical part, along the peripheral channel loop. The peripheral channel loop part and the second cylindrical part are open to the receptacle space 16.

A bottom end of a hollow cylinder 20, of which the top end is closed by a cap 22, is received snugly in the first cylindrical part of the first recessed portion 18, such that the cylinder 20 projects from the first cylindrical part. The cylinder 20 is complementally shaped to the first cylindrical part.

The cylinder 20 has an inlet conduit 24 that projects into an interior 26 of the cylinder 20, through a side of the cylinder 20. Although not illustrated in such detail, the inlet conduit 24 has connecting formations that allow a water inlet pipe from a water reservoir to be connected to it, for water from the water reservoir to be fed into the interior 26 of the cylinder 20, typically under gravity, through a mouth 28 of the inlet conduit 24, thus into the first recessed portion 18, and eventually into the receptacle space 16.

The inlet conduit 24 is provided with a displaceable closure 30 at the mouth 28 thereof. The closure 30 is pivotally displaceable selectively to open and close the mouth 28, thus acting as a water supply control valve.

A buoyant member 32 is received inside the cylinder 20. Being buoyant, the buoyant member 32 is displaceable inside the interior 26 of the cylinder 20 by changes in a water level inside of the cylinder 20 in use.

The buoyant member 32 is connected to the closure 30 by means of a manipulating arm 34, such that
rising displacement of the buoyant member 32 inside the cylinder 20 due to a rising water level causes the manipulating arm 34 to pivot the closure 30 toward the mouth 28 and eventually cause it to close the mouth 28; and
descending displacement of the buoyant member 32 inside the cylinder 20 due to a descending water level causes the manipulating arm 34 to pivot the closure 30 away from the mouth 28 and eventually cause it to open the mouth 28.

Water flow into the interior 26 of the cylinder 20 is therefore allowed when the position of the buoyant member 32 is such that the mouth 28 of the inlet conduit 24 is open, and is disallowed, i.e. stopped, when the position of the buoyant member 32 is such that the mouth of the inlet conduit 24 is closed.

The interior 26 of the cylinder 20 is in fluid communication with the peripheral channel loop part of the first recessed portion 18, and therefore also with the receptacle space 16, through two oppositely located apertures 25 (only one being visible in FIG. 1, and both being visible in FIG. 4) that are provided adjacent to a bottom of the cylinder 20. The apertures align with opposite ends of the channel loop part that open out in the first cylindrical portion, thus establishing fluid communication of the interior 26 of the cylinder 20 with the channel loop and second cylindrical parts, and therefore also with the receptacle space 16. As water rises in the cylinder 20, water would thus also rise in the channel loop part and in the second cylindrical part of the first recessed portion 18. Ultimately, continuous feeding of water into the first recessed portion 18 would cause water to rise into the receptacle space 16.

Limiting the level to which water can rise in the interior 26 of the cylinder 20 therefore amounts to also limiting the level to which water can rise in the first recessed portion 18 and, eventually, in the receptacle space 16. In this regard it will be appreciated that the water level inside interior 26 of the cylinder 20 would mirror the water level in the channel loop and second cylindrical parts of the first recessed portion 18 and, when water has risen into the receptacle space 16, would mirror the water level through the first recessed portion 18 into the receptacle space 16.

The receptacle space 16 is separated into two zones by a separating plate 36 that traverses a cross sectional area of the receptacle space 16. The separation plate 36 is omitted in FIG. 1. The two zones comprise an upper “cultivation” zone 16A and a lower “water supply” zone 16B. The cultivation zone 16A, in use, would contain growth medium (e.g. soil) while the water supply zone 16B, in use, would contain water that would be supplied to the cultivation zone 16A through wicking, as hereinafter described.

The cultivation zone 16A and the water supply zone 16B are virtually completely separated by the separating plate 36, except through two apertures 38, 40 that are defined in the separating plate. In use, a body of growth medium in the cultivation zone 16A would extend into the water supply zone 16B through the apertures 38, 40. Such extension would be contained, however. In this regard, the base 12 has, in addition to the first recessed portion 18, a second recessed portion 42 and a third recessed portion 44 (referred to as “additional recesses” in the summary of invention—these terms are interchangeable) which are open to the receptacle space 16 and which are in register with the apertures 38, 40 in the separating plate 36. Thus, growth medium that extends from the cultivation zone 16A into the water supply zone 16B is contained in the second and third recessed portions 42, 44. It will be appreciated that a major portion of the body of growth medium would therefore be contained in the cultivation zone 16A while a minor portion of the body of growth medium would extend into the water supply zone 16B.

The minor portion of the body of growth medium that would extend into the second and third recessed portions 42, 44, and thus into the water supply zone 16B, would in use serve as a wick for the major portion of the body of growth medium that would be contained in the cultivation zone 16A, drawing water that it contacts in the water supply zone 16B up into the cultivation zone 16A through wicking, i.e. capillary action.

As mentioned above, in use, water that is fed into the interior 26 of the cylinder 20 and thus into the first cylindrical part of the first recessed portion 18 flows, through the apertures 25 adjacent to the bottom of the cylinder 20, from the first cylindrical part into the channel loop and second cylindrical parts of the first recessed portion 18. Once the floor of the first recessed portion 18 has been completely wetted, the water level starts to rise in in the first recessed portion 18, and therefore also in the interior 26 of the cylinder 20. This causes the buoyant member 32 also to rise, thus moving the closure 30 toward the mouth 28 of the inlet conduit 26.

The closure 30, the buoyant member 32 and the manipulating arm 34 are configured such that when the first recessed portion 18 has been filled with water, the mouth 28 of the inlet conduit 24 has not yet been closed. Thus, water continues to flow into the interior 26 of the cylinder 20. Such continued flow of water causes the water level in the first recessed portion 18 to rise above the first recessed portion 18, and therefore into the receptacle space 16. Water then flows along non-recessed portions of the base 12 and eventually encounters the second and third recessed portions 42, 44 that are filled with growth medium. Thus, the minor portion of the body of growth medium that is contained in the second and third recessed portions 42, 44 is wetted in use, which allows for wetting of the major portion of the body of growth medium through wicking.

While there is continuous flow of water into the interior 26 of the cylinder 20, water that in use flows into the second and third recessed portions 42, 44 and wets the minor portion of the body of growth medium therein, would cause the water level in the receptacle space 16 temporarily to stabilize, at least until the second and third recessed portions 42, 44 have been filled with water and/or the growth medium therein has been saturated with water. At that stage the water level would start to rise again, which would include a rise in the water level inside the interior 26 of the cylinder 20. Thus, the buoyant member 32 continues to rise and, ultimately, causes closure of the mouth 28 of the inlet conduit 24 by displacement of the closure 30.

As the major portion of the body of growth medium in the cultivation zone 16A becomes wetted through wicking, the minor portion of the body of growth medium in the second and third recessed portions 42, 44 becomes desaturated of water. This causes the minor portion of the body of growth medium to take up available water from the receptacle space 16. Ultimately, this uptake of available water from the receptacle space 16 causes the water level in the receptacle space 16 to recede, which is mirrored inside the interior 26 of the cylinder 20. This receding water level inside the interior 26 of the cylinder 20 ultimately causes descending displacement of the buoyant member 32, which results in displacement of the closure 30 that re-opens the mouth 28 of the inlet conduit 24, again allowing water to be fed into the interior 26 of the cylinder 20 and be dispensed from it, causing the water level inside the interior 26 of the cylinder 20, and thus also in the first recessed portion 18 and in the receptacle space 16, to rise. Thus, the water level in the receptacle space 16 is restored to a level at which the rising water level inside the interior 26 of the cylinder 20 has displaced the buoyant member 32 such that the closure 30 has again closed the mouth 28 of the inlet conduit 24, and the water level inside the receptacle space 16 thus again stabilises.

Importantly, configuration of the closure 30, the buoyant member 32 and the manipulating arm 34 is such that the maximum level to which water is allowed to rise above non-recessed portions of the base 12 is shallow relative at least to the first, second and third recessed portions 18, 42, 44.

It is regarded as an advantage of the invention as described that the volume of water that is at any time contained in the water supply zone 16B is virtually limited to that which is contained in the first, second and third recessed portions 18, 42, 44 of the base 12, and a shallow volume of water above non-recessed portions of the base 12. Of this water, only that which is in the first recessed portion 18 and on non-recessed portions of the base 12 is not actively being utilised/directly available for uptake by the minor portion of growth medium in the second and third recessed portions 42, 44. This configuration is regarded as not only increasing the efficiency of water utilisation, which is focused to the second and third recessed portions 42, 44 and the growth medium contained therein, but also significantly decreases the total weight of the crop cultivation receptacle 10 in use. It will be appreciated that the combined volume of growth medium and water can make for an impractically heavy crop cultivation receptacle. Since reducing the volume of growth medium is not feasible, reducing the amount of unutilised water, while not impacting negatively on the availability of necessary water, in a manner that automatically makes water available when needed, is regarded as being a novel and inventive feature of the invention as described.

It is noted that the channel loop part and second cylindrical part of the first recessed portion 18 are provided advantageously to promote even distribution of water within the water supply zone 16B across the base 12. While advantageous, the channel loop part and second cylindrical part may, however, be omitted in other embodiments of the invention, provided that there remains fluid communication between the first recessed portion 18 of the base 12 and the receptacle space 16.

It is further noted that the edge portion 13 has an inwardly projecting inclined lip 29. In use, this lip 29 would serve securely to hold captive, inside the receptacle space 18 and on top of the major portion of the body of growth medium that would in use be contained therein, edge portions of an isolation cloth that would traverse an upper surface area of the isolation cloth.

One Embodiment of a Water Reservoir for Providing a Crop Cultivation Assembly of the Invention

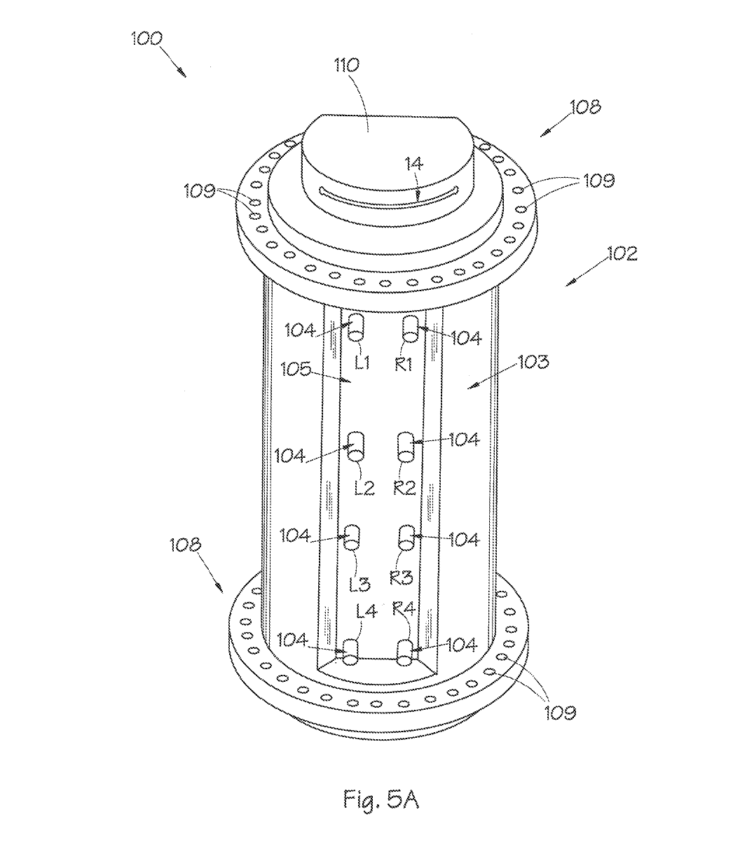

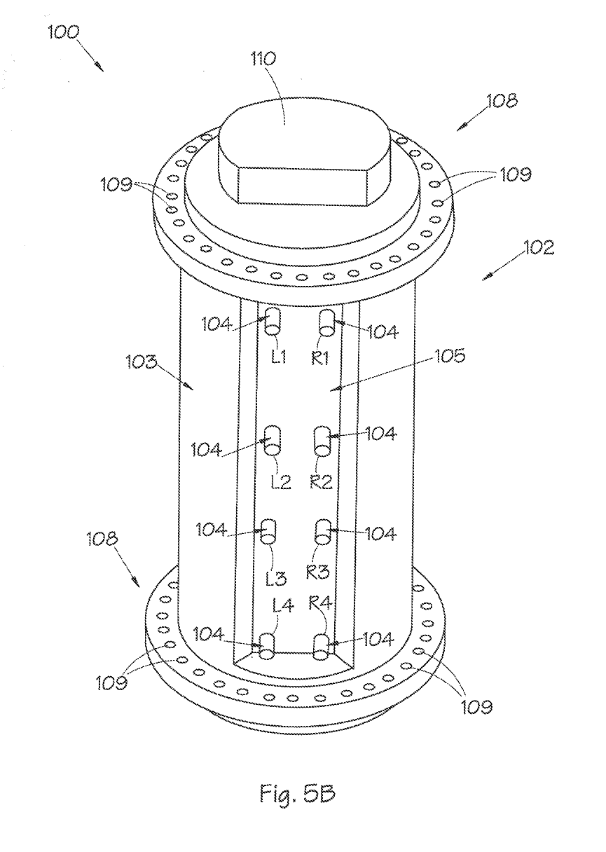

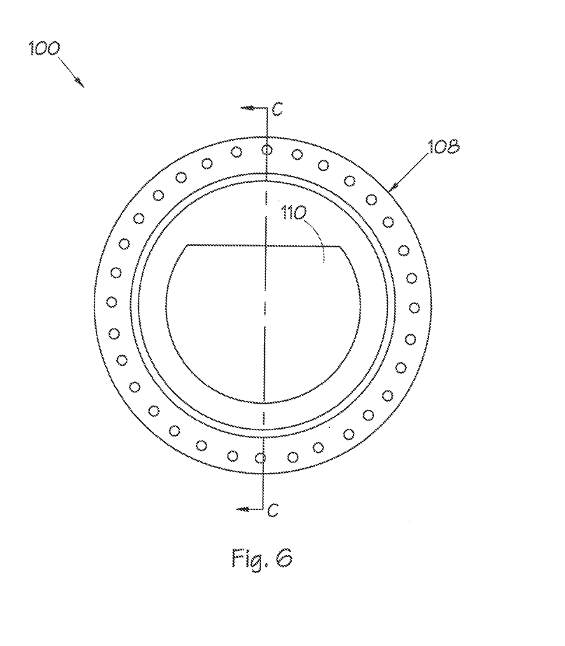

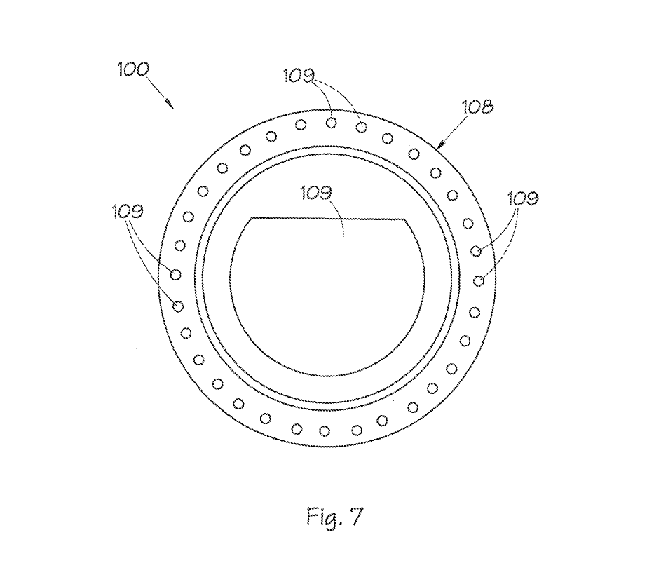

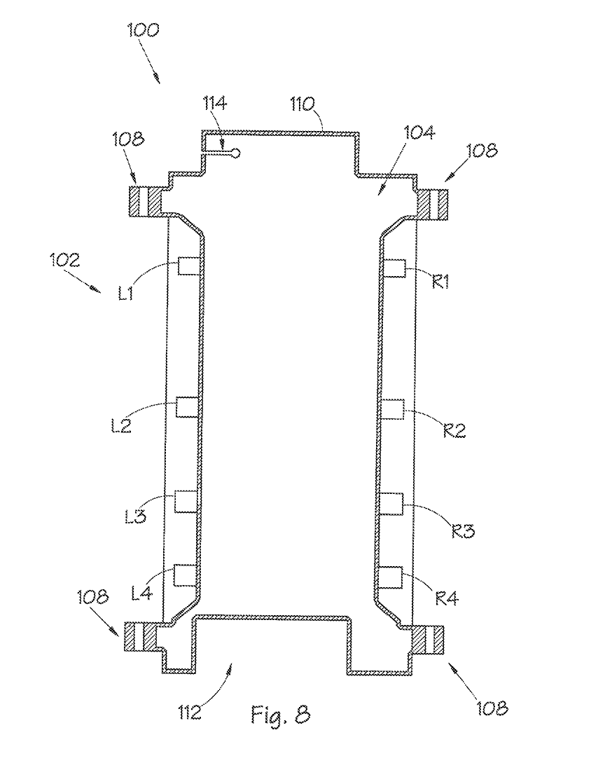

Referring to FIGS. 5 to 8, reference numeral 100 generally indicates one embodiment of a water reservoir that is provided for use with the crop cultivation receptacle of the invention, to supply water to it under gravity. Such a crop cultivation receptacle may, in particular, be the crop cultivation receptacle 10 that is hereinbefore described.

The water reservoir 100 comprises a hollow, generally cylindrical body 102 inside an interior 104 of which water can be contained.

The body 102 is provided with two groups 103 of nipple-like inlet/outlet formations 104, located in respective diametrically opposite recesses 105 which are defined along the length of the body 102. Hereinafter, the formations 104 is, for simplicity, referred to as “outlet” formations, which means that they would serve as discharge ports for water to be discharged from an interior 104 of the body 102. It must be noted, however, that the formations 104 may, in the alternative and as would be determinable from the context, be “inlet” formations, which means that they would serve as charge ports for charging the interior 104 of the body 102 with water.

Each of the groups 103 comprises two parallel columns of four of the outlet formations 104 each, arranged along the length of the body 102. The outlet formations 104 are reference alphanumerically as L1 through L4 from top to bottom for the left-hand column as viewed in each case, and R1 through R4 for the right-hand column.

Each of the outlet formations 104 is independently closed, and each can therefore be selectively independently opened to provide for charging or discharging of water to or from the interior 104 at different levels along the length of the body 102.

Although not illustrated, it is noted that at least one of the outlet formations 104, typically one of the lower ones, e.g. L4 or R4 of the rear group of outlet formations 104, may in use have an aeration pipe connected to it, which aeration pipe extends from the outlet formation 104 to which it is connected and projects in an operatively upward direction, terminating in an open end that is remote from the outlet formation 104. The open end of the aeration pipe may be provided with shielding means to prevent contaminants, e.g. inorganic material or organic material, from accessing water inside the aeration pipe, and therefore also from accessing water inside the interior 104 of the body 102. It will be appreciated that a water level in the interior 104 of the body 102 would be mirrored in the aeration pipe. Thus the aeration pipe, if transparent, can serve as a manometer that provides an indication of the water level inside the interior 104 of the body 102.

Adjacent its top and bottom ends the body 102 comprises respective flange members 108 of circular outline. Each flange member 108 is provided with a plurality of water reservoir mounting apertures 109 that are spaced equiangularly from each other at 11.25° about a virtual geometric centre of a second virtual circle, which is a circle of which the outlines of the respective flange members 108 form part.

The top end of the body 102 is provided with a mounting lug 110 that has a truncated circular outline, i.e. an outline that is part-circular and part-straight. The bottom end of the body 102 defines a mounting recess 112 that is shaped complementally to the mounting lug 110.

The body 102 has, separately of the outlet formations 104, an opening in its top. The opening grants access to the interior 104 of the body 102. Thus, water can be introduced into the interior 104 through the opening. Conveniently, in the body 102, the opening is provided along a side wall of the mounting lug 110, more specifically along its part-circular section. The opening is indicated with reference numeral 114. The opening 114 has a narrow, elongated middle portion that terminates in respective bulged circular ends.

Crop Cultivation Assembly of the Invention Comprising the Water Reservoir

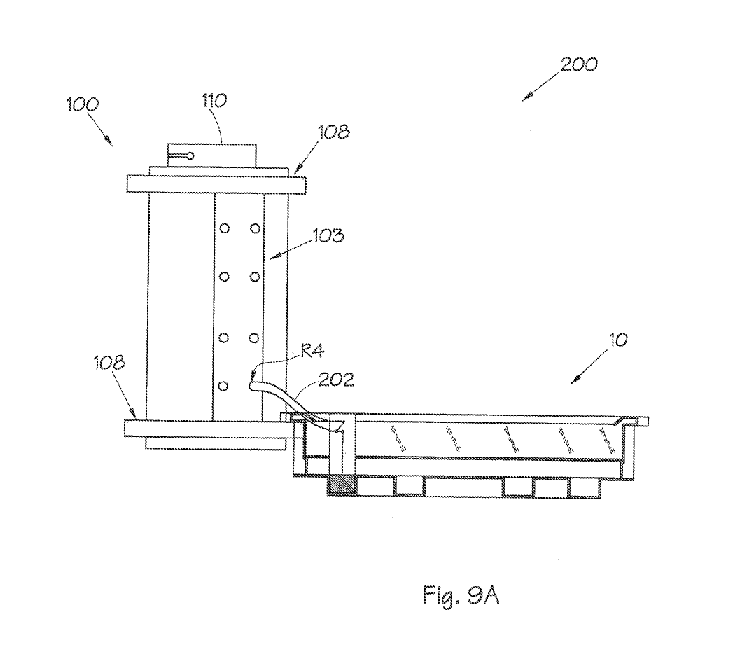

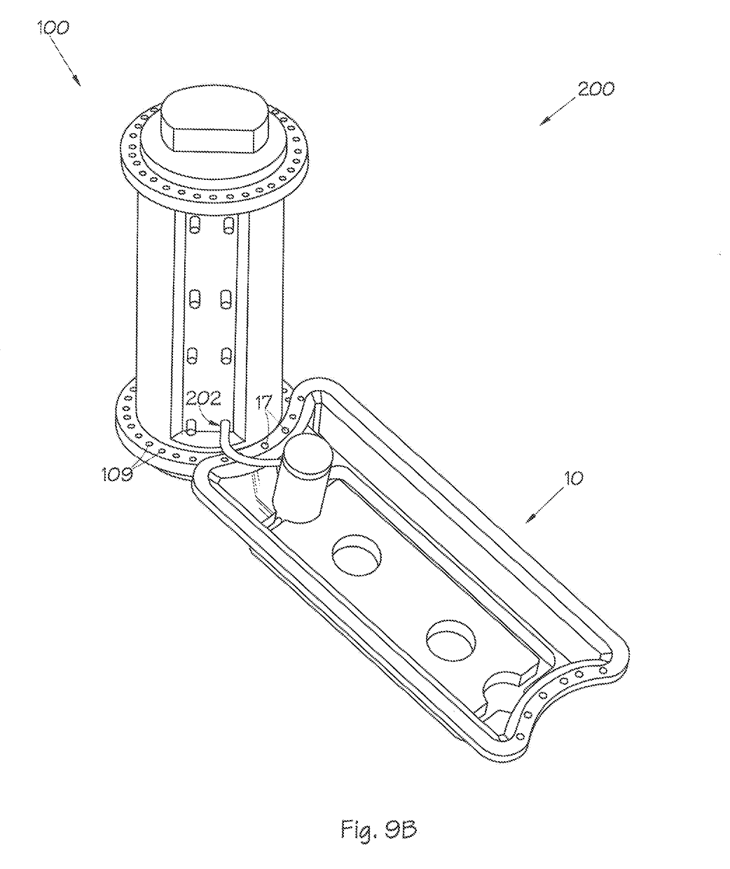

Referring now to FIG. 9, reference numeral 200 generally shows an assembly of the crop cultivation receptacle 10 and the water reservoir 100.

The assembly 200 is provided by aligning at least some of the receptacle mounting apertures 17 with at least some of the water reservoir mounting apertures 109 that are provided on the lower of the two flange members 108 of the body 102 of the water reservoir 100, and securing the receptacle 10 to the body 102 of the water reservoir 100 by means of securing elements, e.g. drop pins, that extend through the aligned receptacle and water reservoir mounting apertures 17, 109.

Furthermore, a pipe 202 is connected between one of the lowermost outlet formations 104 and the inlet conduit 24 of the cylinder 20 of the receptacle 10, to supply water to the interior 26 of the cylinder 20 through the inlet conduit 24 in the manner hereinbefore described, under the force of gravity.

It will be appreciated that the assembly 200 can include another water reservoir 100 at the other end of the receptacle 10, to which other water reservoir 100 the receptacle 10 can be secured in the same manner in which it is secured to the illustrated water reservoir 100. Thus, in an alternative and in fact a preferred embodiment, the assembly 200 would comprise two parallel water reservoirs 100 and the receptacle 10 extending between and being secured to and thus supported by the water reservoirs 100.

The invention envisages, as is described in more detail later on, an arrangement of a plurality of such preferred embodiments of the assembly 200, with the water reservoirs 100 thereof stacked one on top of the other and with their respective receptacles 10 thereby being arranged one above and spaced from another.

Crop Cultivation Arrangement of the Invention Comprising the Crop Cultivation Assembly of the Invention

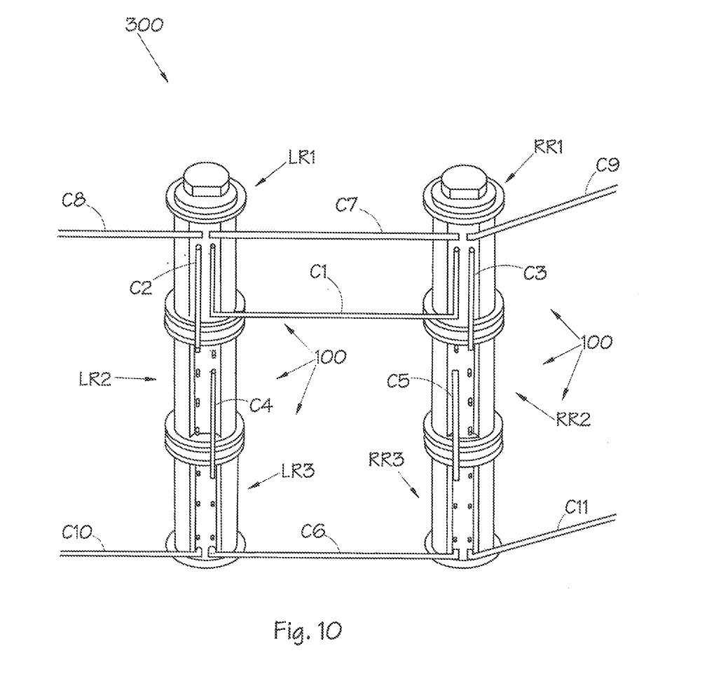

Referring now to FIG. 10 reference numeral 300 shows an arrangement of two side-by-side stacked, tower- or column-like assemblies of the water reservoirs 100.

The tower-like assemblies comprises three pairs of the water reservoirs 100. The water reservoirs 100 of the left-hand tower are referenced alphanumerically from top to bottom as LR1 to LR3, and those of the right-hand tower are referenced from top to bottom as RR1 to RR3. Thus, LR1 forms a pair with RR1, LR2 forms a pair with RR2, and LR3 is paired forms a pair with RR3.

The arrangement 300 is incomplete in that it omits of the receptacles 10 that extend between at least some of the pairs of water reservoirs 100. In a complete configuration, the arrangement 300 would include at least one receptacle 10 that extends between LR1 and RR1 or between LR2 and RR2, or two receptacles 10 of which one extends between the LR1 and RR1 and the other extends between LR2 and RR2. These are presently omitted in order more clearly to illustrate one embodiment of possible pipe connections between the water reservoirs 100.

The water reservoirs 100 of the arrangement 300 are stacked by mating the mounting lug 110 of the body 102 of one water reservoir with the mounting recess 112 of another water reservoir 100. In this manner, the water reservoirs 100 are secured against rotation about a stacking axis along which they are stacked, since truncation of the mounting lug 110 and complemental truncation of the mounting recess 112 prevents rotating displacement of the water reservoirs 100 relative to each other about the stacking axis.

Such stacking of two water reservoirs also aligns the water reservoir mounting apertures 109 of the lower of the two flange members 108 of one water reservoir 100 with the water reservoir mounting apertures 109 of the upper of the two flange members 108 of the other water reservoir 100, providing pairs of aligned water reservoir mounting apertures 109. This allows for the two water reservoirs 100 to be secured to each other against longitudinal separation as well, e.g. by using fastening elements that extend through one or more of the pairs of aligned water reservoir mounting apertures 109.

Naturally, the manner described above of stacking two water reservoirs 100 securely applies evenly when adding a third water reservoir 100 to a stack of two water reservoirs 100.

Turning to pipe connections between the respective water reservoirs of the arrangement 300: As has been described with reference to the assembly 200, one of the lowermost outlet formations 104 (L4 or R4) of one of the water reservoirs 100 that is included in the preferred embodiment of the assembly 200 (which would ultimately preferably form part of the arrangement 300) would be connected to the inlet conduit 24 of the receptacle 10, to supply water to the interior 26 of the cylinder 20 through the inlet conduit 24 in the manner hereinbefore described, under the force of gravity. This pipe connection is not illustrated in FIG. 10, but should be borne in mind. This connection is also, for simplicity, referred to hereinafter as Connection 0 (zero).

Pipe connections that are illustrated in FIG. 10, using the references of outlet formations 104 provided in the description of FIG. 5 above and the references of water reservoirs 100 provided in the earlier description of FIG. 10, include connections between
R2 of LR1 and L1 of RR1 (Connection 1);
L2 of LR1 and L1 of LR2 (Connection 2);
R2 of RR1 and R1 of RR2 (Connection 3);
R2 of LR2 and R1 of LR3 (Connection 4);
L2 of RR2 and L1 of RR3 (Connection 5);
R4 of LR3 and L4 of RR3 (Connection 6); and
R1 of LR1 and L1 of RR1 (Connection 7).

In addition, overflow pipe connections extend off page from L1 of LR1 (Connection 8) and R1 of RR1 (Connection 9) respectively. Furthermore, underflow pipe connections extend from L4 of LR3 (Connection 10) and R4 of RR3 (Connection 11) respectively. The underflow pipe connections are assumed to be closed unless otherwise stated.

As has been described hereinbefore, each of the water reservoirs 100 includes an opening in its top, through which exogenous water can be introduced into its interior 104. In the arrangement 300, exogenous water would only be introduced in this manner into the interior 104 of water reservoirs LR1 and LR2, the tops of which are the only ones that are exposed. For the purpose of describing the operation of the arrangement 300 in FIG. 10, and more particularly water distribution in it, it is assumed that exogenous water would only be introduced into the interior 104 of LR1.

Further, also for describing operation of and water distribution in the arrangement 300, perpetual unbroken feeding of exogenous water into LR1 is assumed.

Feeding water into the interior 104 of LR1 through the opening in its top causes water to rise inside of it. Once the water level reaches L2 and R2, water is discharged, or siphoned, from the interior 104 of LR1 into RR1 (Connection 1) and into LR2 (Connection 2) respectively. Thus, water starts and continues to rise in LR2 and RR1 while there is water being supplied to LR1. The water level in LR1 then remains at L2 of LR1 and R2 of LR1 while such discharge continues.

Once the water level in RR1 reaches R2 of RR1 and the water level in LR2 reaches R2 of LR2 respectively, water is discharged from RR1 to RR2 (Connection 3) and from LR2 to LR3 (Connection 4) respectively. The water levels in RR1 and LR2 then remain at R2 of RR1 and R2 of LR2 respectively while the discharge continues.

Once the water level in RR2 reaches L2 of RR2, water is discharged from RR2 to RR3 (Connection 5). The water level in RR2 remains at L2 of RR2 while the discharge continues.

It will be appreciated that while the underflow pipe connections (Connection 10 and 11) are closed, water rising in LR3 and RR3 would eventually fill the interiors 104 thereof, typically being achieved simultaneously due to connection 6. At that time, discharge of water from LR2 and RR2 to LR3 and RR3 (along Connections 4 and 5 respectively) would no longer be possible, and thus the interiors 104 of LR2 and RR2 would also eventually become filled with water. At that time, discharge of water from LR1 and RR1 to LR2 and RR2 (along Connections 2 and 3 respectively) would no longer be possible, and thus the interiors of LR1 and RR1 would also eventually become filled with water.

Thus, the arrangement 300 would become fully charged with water, and any additional water that is fed to LR1 would be discharged from LR1 across to RR1 (Connection 7), from LR1 along overflow Connection 8, and from RR1 along overflow Connection 9.

It will also be appreciated that, from a fully charged condition and without further feed of water to LR1,
any unused capacity in LR3 would be replenished from LR2 until the water level in LR2 is below R2 of LR2;
any unused capacity in LR2 would be replenished from LR1 until the water level in LR1 is below L2 of LR2;
any unused capacity in RR3 would be replenished from RR2 until the water level in RR2 is below L2 of RR2; and
any unused capacity in RR2 would be replenished from RR1 until the water level in RR1 is below R2 of RR1.

It will also be appreciated that the manner in which the water reservoirs LR1 to LR3 and RR1 to RR3 are interconnected by connections 1 through 7 addresses the fact that no exogenous water is being supplied to RR1.

The overflow connections, i.e. Connections 8 and 9, may extend to other water reservoirs 100 of further arrangements of pairs of water reservoirs 100 that are similar to the arrangement 300. Exemplary configurations including such further arrangements are discussed later.

The arrangement 300 may in one embodiment, although not illustrated, include a pump to transfer water that is available in LR3 and/or RR3, for discharge through the underflow Connections 10 and 11, to other water reservoirs 100 in the arrangement 300, or to those of an extended embodiment thereof as described below.

It is regarded as being a particular advantage of the water reservoir 100, as described, that the arrangements 103 of outlet formations 104 enable a selection to be made as to the level at which water would be siphoned from a higher reservoir 100 to a lower reservoir 100. The configuration of the reservoir 100 is preferably such that siphoning at L3 or R3 results in the reservoir 100 becoming about 30% filled with water, before siphoning commences, and such that siphoning at L2 or R2 results in the reservoir 100 becoming about 60% filled with water, before siphoning commences. This feature of the reservoir 100 allows a user to limit the extent to which the reservoir 100 is filled in use, thereby to ensure that water is discharged into a lower reservoir 100, e.g. in cases of low rainfall.

Referring now to FIG. 11, the uppermost pairs of water reservoirs 100 of the arrangement 300 of FIG. 10, comprising LR1, RR1 and LR2, RR2, are shown omitting the pipe connections of FIG. 10, to show conceptually how one of the crop cultivation receptacles 10 of FIG. 1, which is also illustrated conceptually, would be mounted such that it extends between the uppermost pair of water reservoirs, i.e. LR1, RR1.

The manner in which the receptacle 10 would be mounted such that it extends between two of the water reservoirs 100 has already been described above with reference to the preferred embodiment of the assembly 200. That description applies evenly with respect to the mounting of two of the receptacles 10 such that they extend respectively between LR1 and RR1 and between LR2 and RR2.

In addition to the description of the preferred embodiment of the assembly 200, the following should be noted: Two pairs of parallel mounting rods 402 extend respectively between the lower of the mounting flange members 108 of LR1 and RR1 and the lower of the mounting flange members of LR2 and RR2. Ends of the respective mounting rods 402 are secured to the respective flange members 108 by means of respective fastening elements (not illustrated) that extend through respective ends of the rods 402 and respective water reservoir mounting apertures 109.

The spacing of the mounting rods 402 of each pair of mounting rods from each other is such that the base 12 and walls 14 of the receptacle 10 can pass between them, and that the mounting slots 21 of side parts of the peripheral edge portion 13 engages the rods 402 snugly. Thus, each pair of mounting rods 402 supports the receptacle 10 that is received between the rods 402 along the side parts of the peripheral edge portion 13 of the receptacle 10.

Once one or more of the receptacles 10, respectively, have thus been mounted between respective one or more pairs of the water reservoirs 100 of the arrangement 300, and Connection 0 has been made between one of the lowermost outlet formations 104 (L4 or R4) of one of the water reservoirs 100 of each pair and the inlet conduit 24 of the receptacle 10 that extends between that pair, the arrangement 300 is effectively ready to receive and distribute exogenous water, and thus to be used for crop cultivation in the receptacles 10.

Harvesting of Rain Water as Exogenous Water

Rain water is preferably harvested as exogenous water, to be fed to the water reservoir 100 labelled as LR1 in the illustrated embodiment of the arrangement of the invention, by means of a rain water harvesting member in the form of a piece of sheet material.

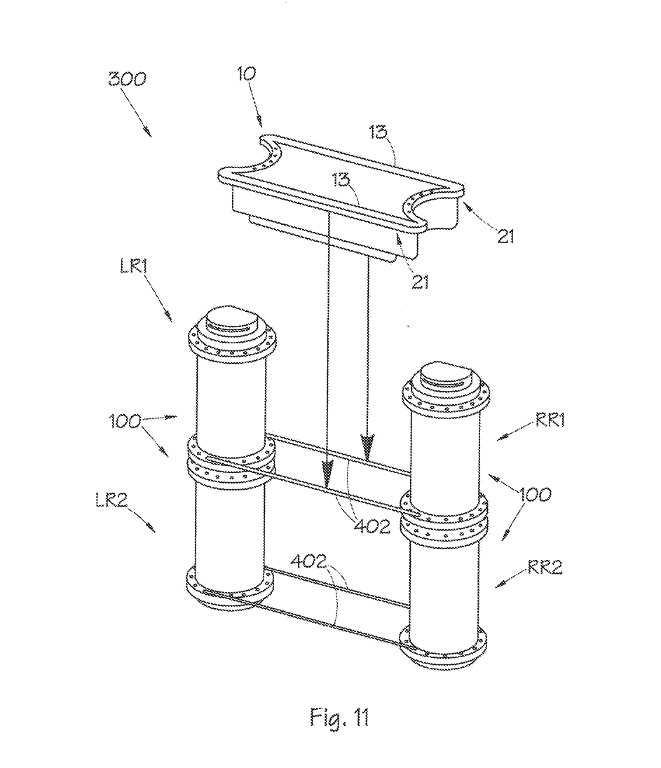

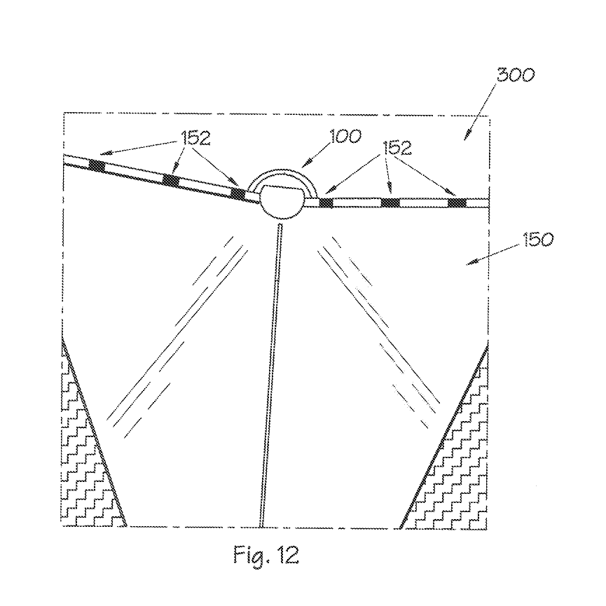

Referring to FIG. 12, reference numeral 150 shows part of a rain water harvesting member in the form of a piece of sheet material.

A part of the sheet material 150 has been shaped into a funnel that is directed to and terminates at the mounting lug 110 of the reservoir 100 labelled as LR1.

At the mounting lug 110, the sheet material 150 as a semi-circular cut-out that is defined in it, shaped complementally to the part-circular portion of the mounting lug 150. Thus the sheet material 150 snugly hugs the mounting lug 110, maximising the amount of rain water, of that which is collected by the sheet material, which is fed into the opening 114.

The sheet material 150 is drawn taut by means of clamps 152 that fasten the sheet material to perimeter piping of the arrangement 300, particularly when it is and extended embodiment thereof as described below.

Crop Irrigation in the Crop Cultivation Arrangement of the Invention

The crop cultivation arrangement of the invention, specifically as described with reference to the arrangement 300, advantageously automatically distributes an abundance of water, e.g. during a rain spell or season, evenly between the water receptacles 100 thereof. Thus, even irrigation of crops cultivated in the receptacles 10 is promoted.

During a dry spell, when water for example remains only in the lowest water reservoirs 100, i.e. LR3 and RR3, which in the illustrated embodiment do not supply water to any receptacle 10, water can be pumped to the higher water reservoirs 100, i.e. LR1 and RR1, or to intermediate water reservoirs 100, i.e. LR2 and RR2, for irrigation of crops in their respective receptacles 10. It is noted, however, that this situation would evenly apply when LR3 and RR3 do have a receptacle 10 extending between them, to which receptacle 10 one of LR3 and RR3 would be arranged to supply water under gravity. Thus, it is envisaged that the lower pair of reservoirs LR3 and RR3 may provide an assembly 200 in accordance with the invention.

Extension of the Crop Cultivation Arrangement of the Invention

With reference to FIG. 9b, it would be noted that the receptacle 10, when mounted to one, or extending between two of the water reservoirs 100, occupies less than half of the receptacle mounting apertures 109.

Thus, the configuration of the flange member 108 is such that there is scope available to mount two, or even three, of the receptacles 10 to the same flange member 108 of one of the water reservoirs 100, wherein the second and, optionally, third of the two receptacles 10 extend/s in a different direction/different directions than the first of the two or three receptacles 10.

The opposite end of the second receptacle 10 would then be available for mounting to a further water reservoir 100, which may be a water reservoir that forms part of another arrangement that is identical to the arrangement 300.

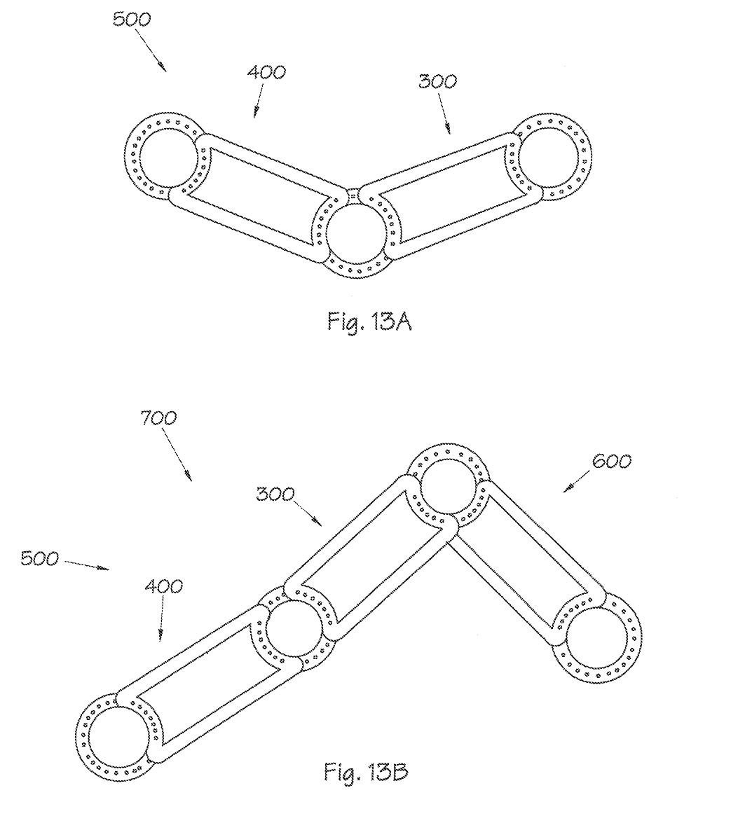

The possibility to thus extend the arrangement 300 is illustrated conceptually in FIG. 13a, which shows the stacked tower of water reservoirs LR1, LR2 and LR3 of the arrangement 300 being used as basis to provide another arrangement referenced by numeral 400 that is identical to arrangement 300, and collectively referred to by reference numeral 500.

In FIG. 13b, the arrangements 300 and 400 are spaced at a wider angle from each other, and the arrangement 500 is further extended with a further arrangement, referenced by numeral 600, that is also identical to arrangement 300, thereby to provide a further extended arrangement that is reference by numeral 700.

Without going into further detail, it will be appreciated that a multitude of configurations is possible in extending the arrangement 300 in the manner in which it is extended in providing arrangements 500 and 700, and further.

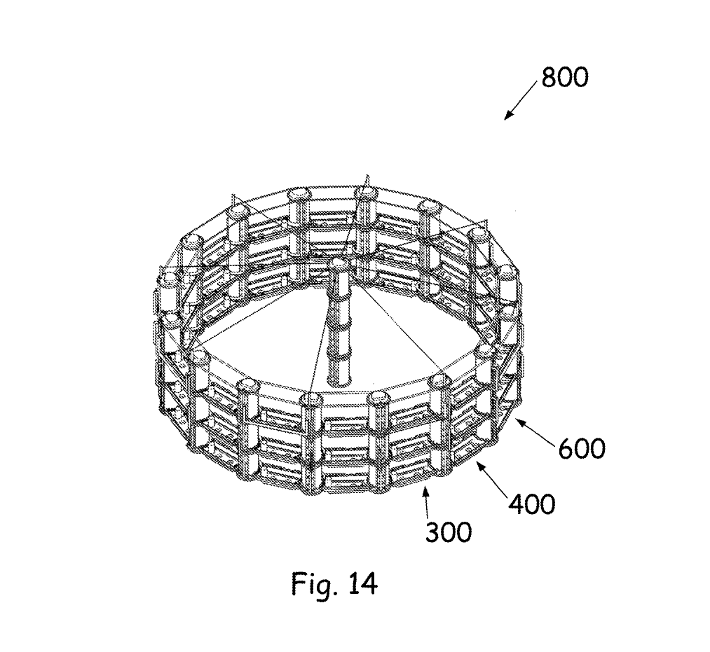

One particularly advantageous configuration of the arrangement of the invention that is envisaged is one which comprises pairs of stacked water reservoirs 100 having receptacles extending between them, wherein the water reservoirs 100 are arranged along an endless path, e.g. a circular path as generally indicated by reference numeral 800 in FIG. 14. Thus, a space 802 is defined between the water reservoirs 100. By arranging a rain water harvesting member, such as the piece of sheet material 150, such that it traverses the space 802, the space 802 becomes a sheltered space, which could be useful as shelter for humans and/or storage space for equipment.

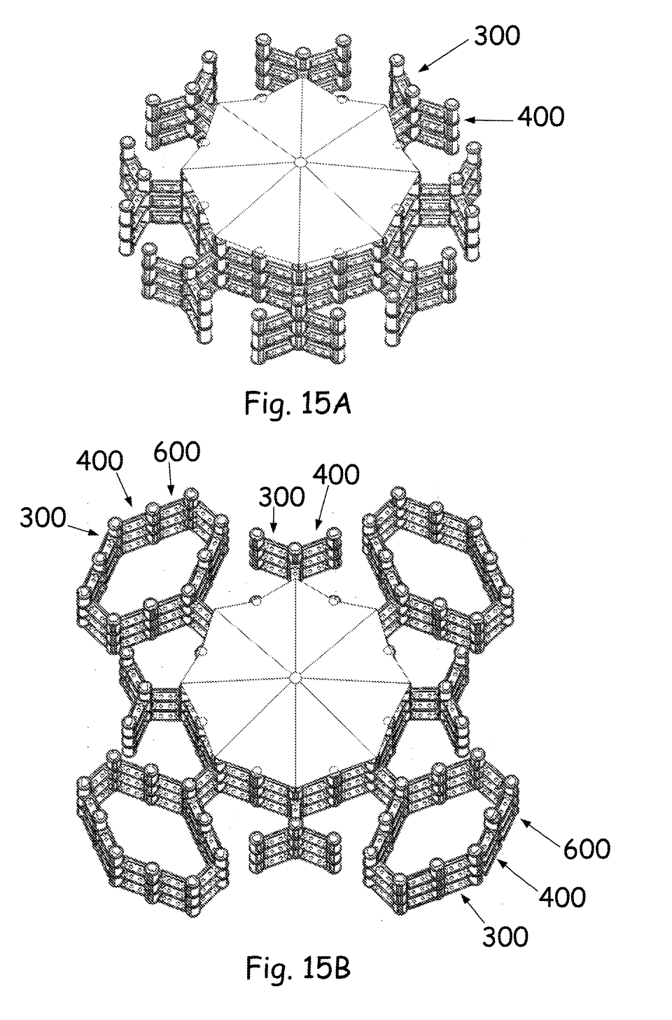

Further extended configurations that could possibly be created are conceptually illustrated in FIGS. 15a and 15b.

Preventing Growth of Algae

It is envisaged that all of the components of the receptacle 10, water reservoir 100 assembly 200 and arrangement 300, as well as the components of extensions of the arrangement 300, would be of an opaque material, thus preventing sunlight from irradiating water inside such components. In this manner, the potential for growth of algae in the water would be prevented, or at least reduced.

### CONCLUSION

The present invention thus ultimately provides a modular crop cultivation and water harvesting system. The Applicant is aware that such systems have received attention from inventors in the past, but believes that the features of the present invention are distinct and inventive over existing systems.

As has been contended hereinbefore, the configuration of the cultivation receptacle of the invention is regarded as providing a much more practical option for vertical cultivation of crops than existing receptacles that does not address excessive weight considerations associated with unutilised water volumes inside such receptacles.

In addition features of the crop cultivation assembly of the invention which allow it to provide the crop cultivation arrangement of the invention and extend this arrangement to the configurations that have been described, and further configurations, illustrate the beneficial versatility of the invention.

The invention, overall, is regarded offering a means of sustainably bringing relief to people encountering the challenges that have been discussed hereinbefore, including refugees in particular.

1. A crop cultivation receptacle which comprises
a base;
side walls that project from the base;
a receptacle space that is defined between the base and the side walls, in which receptacle space water and a body of plant growth medium for cultivating plants can, in use, be held;
a first recess in the base, the first recess thus being sunken relative to the base, and the first recess being in fluid communication with the receptacle space;
a water supply control valve that is arranged to supply, in use, water to the receptacle from a water supply, and that can be opened and closed selectively to allow and disallow such supply of water; and
a buoyant member that is arranged for buoyant displacement along at least a part of the first recess, wherein displacement of the buoyant member is caused, in use, by changes in a level of water that is contained in the first recess, or by changes in a level of water that is contained in the receptacle space when the first recess has overflowed with water, such that
the water supply control valve is closed due to displacement of the buoyant member by the level of water reaching, in use, a predetermined maximum level in the receptacle space; and
the water supply control valve is opened due to displacement of the buoyant member by the level of water reaching, in use, a predetermined minimum level, in the first recess.

2. The receptacle of claim 1, which comprises an additional recess in the base, into which recess, in use, a minor part of a body of growth medium, which is contained in the receptacle space, extends.

3. The receptacle of claim 1, wherein the receptacle space is separated, by a separation member that traverses the receptacle space, into a water supply zone, which includes the base and the first recessed portion, and a cultivation zone.

4. The receptacle of claim 3, wherein the separation member has an aperture therein that is in register with the additional recess, and through which aperture the minor part of the body of growth medium, in use, extends into the additional recess.

5. The receptacle of claim 1, wherein the receptacle space has a volume in a range of from 3 to 5 litres.

6. The receptacle of claim 1, wherein the receptacle space has a depth, measured to the base, in a range of from 50 mm to 75 mm.

7. The receptacle of claim 3, wherein the separation member is spaced from the base.

8. The receptacle of claim 7, wherein space between the separation member and the base is in a range of from 6 mm to 18 mm.

9. A crop cultivation assembly, which comprises
the crop cultivation receptacle of claim 1; and
a water reservoir which supports the crop cultivation receptacle clear of a ground surface on which the water reservoir is supported and which supplies water to the receptacle through the control valve of the receptacle, under gravity.

10. An extended crop cultivation assembly which comprises
a plurality of crop cultivation receptacles of claim 1; and
one or a plurality of support structures between which the receptacles extend and which support the receptacles clear of a ground surface on which the support structures are supported,
wherein the receptacles are arranged in a stacked configuration, one above the other, with clearance between them.

11. The extended crop cultivation assembly of claim 10, wherein either (i) at least some of the support structures comprise water reservoirs, or (ii) at least some of the support structures comprise stacked assemblies of two or more water reservoirs that are interconnected for fluid communication, wherein at least some of said water reservoirs supply, in use, water to at least one receptacle through the water supply control valve of the receptacle.

12. The extended crop cultivation assembly of claim 11, wherein at least some of the water reservoirs of a first support structure and at least some of the water reservoirs of a second support structure are interconnected for fluid communication between the reservoirs.
